(19) United States
(12) Patent Application Publication
(10) Pub. No.: US 2024/0263106 A1
(43) Pub. Date: Aug. 8, 2024

(54) FLUORINE-BASED SOLVENT COMPOSITION

(71) Applicant: CHEMOURS-MITSUI FLUOROPRODUCTS CO., LTD., MINATO-KU, TOKYO (JP)

(72) Inventor: HIDEAKI KIKUCHI, SHIZUOKA-SHI, SHIZUOKA (JP)

(73) Assignee: CHEMOURS-MITSUI FLUOROPRODUCTS CO., LTD., MINATO-KU, TOKYO (JP)

(21) Appl. No.: 18/569,709

(22) PCT Filed: Jul. 20, 2022
(86) PCT No.: PCT/US2022/037698

§ 371 Date: Dec. 13, 2023

(30) Foreign Application Priority Data
Jul. 29, 2021 (JP) 2021-123908

(51) Int. Cl. C11D 7/50

(52) U.S. Cl. CPC C11D 7/5063; C11D 7/5054

(57) ABSTRACT

Disclosed are azeotropic or azeotrope-like compositions containing a hydrofluoroether and a chlorotrifluoropropene. The hydrofluoroether is at least one of methyl nonafluorobutyl ether, ethyl nonafluorobutyl ether, 2,2,2-trifluoroethyl-1,1,2,2-tetrafluoroethyl ether including isomers thereof. The compositions are azeotropic or azeotrope-like and are useful in cleaning applications.

The present invention relates to an azeotropic composition or an azeotropic-like composition containing a hydrofluoroether and a chlorotrifluoropropene

In many industries, fluorine-based solvents including chlorofluorocarbons (CFC), hydrochlorofluorocarbons (HCFC), hydrofluorocarbons (HFC), and other halogenated hydrocarbons have been conventionally used in a wide range of applications including aerosol propellants, refrigerants, solvents, cleaning agents, foaming agents for thermoplastic and thermosetting foams, heating media, gaseous dielectric bodies, fire extinguishing agents and fire controlling agents, power cycle working fluids, polymerization media, fine particle removing fluids, carrier fluids, buffing compounds, substitution drying agents, and the like.

However, CFCs and HCFCs are known as ozone-depleting substances. In particular, HCFCs represented by HCFC-225 have been widely used due to their nonflammability, excellent polymer compatibility, stability, and the like. However, HCFCs have ozone depletion potential and a high global warming potential, and therefore were fully phased out in 2019.

On the other hand, although HFCs do not pose a risk of depleting the ozone layer, HFCs do affect global warming as a greenhouse gas. Therefore, an alternative product is required, which has low environmental impact, in other words, an ozone depletion potential of zero and a very low global warming potential.

Alternative products that have been developed include hydrochlorofluoroolefins (HCFO), hydrofluoroolefins (HFO), perfluoroolefins (PFO), and hydrofluoroethers (HFE).

Among these, HCFOs are particularly known to have excellent oil removal properties but have strong polymer attack properties (causing polymer cloudiness, cracking, dissolution, and the like), and thus there is a problem in that they cannot be used on many products containing polymers.

Meanwhile, HFEs such as 1,2,2,2-tetrafluoroethyl-heptafluoropropyl ether, 1,1,1,2,3,3-hexafluoro-2-heptafluoropropyloxy-3-(1,2,2,2-tetrafluoroethoxy)propane, heptafluoropropyl methyl ether, ethyl-1,1,2,2-tetrafluoroethyl ether, methyl nonafluorobutyl ether, and ethyl nonafluorobutyl ether have an ozone depletion potential of zero, low global warming potential, and low polymer attack properties, and are therefore proposed as solvents for a variety of uses.

Furthermore, it is known that azeotropic compositions with a constant boiling point property that are not fractionated during use or distilled during recovery when used as a cleaning agent or the like, in other words, compositions that are not fractionated during boiling and evaporation, are useful (for example, Patent Document 3, Patent Document 4, and Patent Document 5). However, as described in Patent Document 1, predicting whether or not an azeotropic composition will be formed is theoretically impossible, resulting in continued search for new azeotropic compositions with excellent properties for various combinations.

### PRIOR ART DOCUMENTS

### Patent Documents

[Patent Document 1] JP 2017-110035 A
[Patent Document 2] WO 2019/213193
[Patent Document 3] Japanese PCT Application H6-501949
[Patent Document 4] Japanese PCT Application 2013-514444
[Patent Document 5] Japanese PCT Application 2012-528922
[Patent Document 6] WO 2018/092780
[Patent Document 7] JP H10-036894 A
[Patent Document 8] JP 2002-256295 A

### SUMMARY OF THE INVENTION

In order to solve the aforementioned problems, an object of the present invention is to provide a novel azeotropic composition or azeotrope-like composition that can be used in a wide range of industrial applications.

### Means for Solving the Problem

The present inventors discovered that a composition containing hydrofluoroether (HFE) with an ozone depletion potential of zero and low global warming potential and chlorotrifluoropropene with excellent oil removal properties is a composition with high safety, that is friendly to the global environment, has excellent polymer compatibility (where polymer attack properties are suppressed), and forms an azeotropic composition or azeotrope-like composition that exhibits behavior like a single compound, thereby achieving the present invention.

In other words, the present invention is characterized by the following points.
1. An azeotropic composition or an azeotrope-like composition containing a hydrofluoroether and a chlorotrifluoropropene, the azeotropic composition or azeotrope-like composition having a composition in which a temperature difference of a temperature indicated by a gas-phase line and a temperature indicated by a liquid-phase line is within 2° C.
2. The azeotropic composition or the azeotropic-like composition according to 1. above, being a cleaning agent composition.
3. The azeotropic composition or the azeotropic-like composition according to 1. or 2. above, the hydrofluoroether being at least one type selected from methyl nonafluorobutyl ether, ethyl nonafluorobutyl ether, 2,2,2-trifluoroethyl-1,1,2,2-tetrafluoroethyl ether, and isomers thereof.
4. The azeotropic composition or the azeotropic-like composition according to 1. or 2. above, the chlorotrifluoropropene being at least one type selected from 1-chloro-2,3,3-trifluoro-1-propene, 1-chloro-3,3,3-trifluoro-1-propene, and isomers thereof.
5. The azeotropic composition or the azeotropic-like composition according to any of 1. to 4. above, consisting of 0.1 to 83.0 mass % of methyl nonafluorobutyl ether and 17.0 to 99.9 mass % of 1-chloro-2,3,3-trifluoro-1-propene.
6. The azeotropic composition or the azeotropic-like composition according to any of 1. to 4. above, consisting of 0.1 to 40.5 mass % of methyl nonafluorobutyl ether and 59.5 to 99.9 mass % of 1-chloro-3,3,3-trifluoro-1-propene.
7. The azeotropic composition or the azeotropic-like composition according to any of 1. to 4. above, consisting of 0.1 to 35.0 mass % of ethyl nonafluorobutyl ether and 65.0 to 99.9 mass % of 1-chloro-2,3,3-trifluoro-1-propene.
8. The azeotropic composition or the azeotropic-like composition according to any of 1. to 4. above, consisting of 0.1 to 99.9 mass % of 2,2,2-trifluoroethyl-1,1,2,2-tetrafluoroethyl ether and 0.1 to 99.9 mass % of 1-chloro-2,3,3-trifluoro-1-propene.
9. A method of cleaning goods using the azeotropic composition or the azeotropic-like composition according to any of 1. to 8. above.

### Effect of the Invention

According to the present invention, a composition can be provided, having an ozone depletion potential of zero and a very low global warming potential.

The azeotropic composition or azeotropic-like composition of the present invention is a composition containing a hydrofluoroether and a chlorotrifluoropropene that has excellent oil solubility, and is a composition having high safety, that is friendly to the global environment, and has excellent polymer compatibility (where polymer attack properties are suppressed). The present invention also has advantages of being an azeotropic composition or azeotrope-like composition exhibiting the same behavior as a single compound, and is not flammable.

### BRIEF DESCRIPTION OF THE DRAWINGS

FIG. 1 shows a gas-liquid equilibrium curve of Example 1.

FIG. 2 shows a gas-liquid equilibrium curve of Example 2.

FIG. 3 shows a gas-liquid equilibrium curve of Example 3.

FIG. 4 shows a gas-liquid equilibrium curve of Example 4.

FIG. 5 shows a gas-liquid equilibrium curve of Example 5.

FIG. 6 shows a gas-liquid equilibrium curve of Example 6.

### DESCRIPTION OF THE PREFERRED EMBODIMENTS

The present invention will be described in detail hereinafter.

The azeotropic composition or azeotropic-like composition of the present invention essentially contains hydrofluoroether (HFE) and chlorotrifluoropropene (HCFO-1233), and both components together preferably account for 50 mass % or more, more preferably 55 mass % or more, and even more preferably 60 mass % or more of the composition.

In the present invention, HFE, being one component, is not limited to a structural isomer/stereoisomer, and may be a single isomer or a mixture of isomers. Preferable examples include at least one type selected from methyl nonafluorobutyl ether, ethyl nonafluorobutyl ether, 2,2,2-trifluoroethyl-1,1,2,2-tetrafluoroethyl ether, and isomers thereof.

Moreover, HCFO-1233, being another component, is known to have various isomers, but HCFO-1233 used in the present invention is not particularly limited to structural isomers and stereoisomers thereof. Furthermore, the used HCFO-1233 may be a single isomer or a mixture of isomers. Specifically, it is preferably 1-chloro-2,3,3-trifluoro-1-propene (HCFO-1233yd), 1-chloro-3,3,3-trifluoro-1-propene (HCFO-1233zd), or a mixture thereof. In addition, HCFO-1233yd is preferably cis-HCFO-1233yd or a mixture containing cis-HCFO-1233yd.

As acknowledged within the relevant technical field, an azeotrope composition is a mixture of two or more differing substances, which are in liquid format under given pressure conditions, and substantively boil at a specific temperature; wherein, said temperature is either higher or lower than the boiling temperature of the individual components and provides a vapor composition substantially the same as the overall liquid composition during boiling (For example, see M. F. Doherty and M. F. Malone, Conceptual Design of Distillation Systems, McGraw-Hill (New York), 2001, pp. 185-186, 351-359).

Here, the boiling point of a composition composed of the azeotropic composition is known to be maximized or minimized by making various changes to the mixed liquid composition when measuring the gas-liquid equilibrium relationship at constant pressure.

Therefore, an essential feature of an azeotropic composition is that at a given pressure, the boiling point of the liquid composition is fixed, and the composition in the gas-phase of the composition during boiling is essentially the composition in the liquid-phase during boiling (in other words, no fractionation of the components of the liquid composition occurs). It is also recognized in this technical field that, when an azeotropic composition is boiled at different pressures, both the boiling point and the mass percentage of each component of the azeotropic composition may change. Therefore, an azeotropic composition may be defined from the perspective of a unique relationship that exists between the components, from the perspective of the compositional range of the components, or from the perspective of an exact mass percentage of each component of the composition characterized by a fixed boiling point at a specified pressure.

The “azeotropic-like composition” of the present invention is a composition that behaves like an azeotropic composition (that is, it has specific boiling point characteristics and tends not to fractionate when boiling or evaporating); in other words, a liquid-phase composition and a gas-phase composition thereof are infinitely close, meaning changes do not readily occur overtime. In a gas-liquid equilibrium curve, it is preferable that a difference in temperature for a liquid-phase temperature and a gas-phase temperature under a given pressure exhibited by a composition be within 2° C. It is more preferable that the difference in temperature be within 1° C., and even more preferable that it be within 0.5° C. This is in contrast to a non-azeotrope-like composition in which the gas-liquid composition changes substantially during boiling or evaporation.

The azeotropic composition or azeotropic-like composition containing the hydrofluoroether and chlorotrifluoropropene of the present invention preferably has a boiling point at atmospheric pressure within a range of 30 to 100° C., preferably 35 to 100° C., and more preferably 40 to 80° C.

In the present invention, when the chlorotrifluoropropene is 1-chloro-2,3,3-trifluoro-1-propene (HCFO-1233yd), the azeotropic composition or azeotropic-like composition of the present invention preferably has a boiling point at atmospheric pressure of 50 to 58° C., and more preferably 51 to 58° C.

A compounded amount of hydrofluoroether corresponding thereto is preferably, methylnonafluorobutyl ether: HCFO-1233yd=0.1 to 83.0:17.0 to 99.9 mass %, and more preferably 2.0 to 80.0:20.0 to 98.0 mass %. Moreover, for ethylnonafluorobutyl ether: HCFO-1233yd, 0.1 to 35.0:65.0 to 99.9 mass % is preferable, and 0.1 to 30.0:70.0 to 99.9 mass % is more preferable. For 2,2,2-trifluoroethyl-1,1,2,2-tetrafluoroethyl ether: HCFO-1233yd=0.1 to 99.9:0.1 to 99.9 mass % is preferable, and 1.0 to 99.0:1.0 to 99.0 mass % is more preferable.

Specific minimum boiling azeotropes were identified for several of the compositions. A minimum boiling azeotrope was identified for the composition of methyl nonafluorobutyl ether and 1-chloro-2,3,3-trifluoro-1-propene at a ratio of 45:55 mass %, having a boiling point at atmospheric pressure of 51° C. A minimum boiling point azeotrope was identified for the composition of ethyl nonafluorobutyl ether and 1-chloro-2,3,3-trifluoro-1-propene at mass % ratio of 2.8 to 11.5:88.5 to 97.2, having a boiling point at atmospheric pressure of 54.9° C. A minimum boiling point azeotrope was identified for the composition of 2,2,2-trifluoroethyl-1,1,2,2-tetrafluoroethyl ether and 1-chloro-2,3,3-trifluoro-1-propene at mass % ratio of 45:55 to 97.2, having a boiling point at atmospheric pressure of 53° C.

When the HFE is less than 5.0 mass % (in other words, when the amount of HCFO is higher than the HFE), polymer attack properties may increase. Conversely, when the HFE exceeds 95.0 mass % (in other words, when the amount of HCFO is lower than the HFE), the oil removal rate may be reduced.

In the present invention, when the chlorotrifluoropropene is 1-chloro-3,3,3-trifluoropropene (HCFO-1233zd), the azeotropic composition or azeotropic-like composition of the present invention preferably has a boiling point at atmospheric pressure of 38 to 46° C., and more preferably 39 to 45° C.

Additionally, when the chlorotrifluoropropene is 1-chloro-3,3,3-trifluoro-1-propene (HCFO-1233zd), a compounded amount of hydrofluoroether is preferably, methylnonafluorobutyl ether: HCFO-1233zd=0.1 to 40.5:59.5 to 99.9 mass %, and more preferably 0.1 to 35.0:65.0 to 99.9 mass %. Moreover, for ethylnonafluorobutyl ether: HCFO-1233zd, 0.1 to 11.0:89.0 to 99.9 mass % is preferable. For 2,2,2-trifluoroethyl-1,1,2,2-tetrafluoroethyl ether: HCFO-1233zd=0.1 to 38.0:62.0 to 99.9 mass % is preferable.

For the compounded amount, when the HFE is less than 10.0 mass % (in other words, when the amount of HCFO is higher than the HFE), polymer attack properties may increase. Conversely, when the HFE exceeds 75.0 mass % (in other words, when the amount of HCFO is lower than the HFE), the oil removal rate may be reduced.

The azeotropic composition or azeotropic-like composition of the present invention may contain one or more types of nitroalkanes, epoxides, furans, benzotriazoles, phenols, amines, or phosphates as stabilizers if necessary, and the added amount thereof is 0.01 to 5.00 mass %, and preferably 0.05 to 0.50 mass % with regard to the composition.

Additionally, the azeotropic composition or azeotrope-like composition of the present invention may, provided it is not detrimental to the attributes of the present invention, contain other components such as alcohols, ketones, ethers, esters, hydrocarbons, amines, glycol ethers or siloxanes, as required.

The azeotropic composition or azeotrope-like composition of the present invention has an ozone depletion potential (ODP) of 0, along with a global warming potential (GWP) roughly below 100, preferably below 50 and more preferably below 10. Herein, the ODP and GWP in the present invention are defined in the World Meteorological Organization's report, “Scientific Assessment of Ozone Depletion, 2002”.

The azeotropic composition or azeotrope-like composition of the present invention can be used in a wide range of applications in which halogenated hydrocarbons were conventionally used, such as aerosol propellants, refrigerants, solvents, cleaning agents, fine particle removing fluids, foaming agents for thermoplastic and thermosetting foams (foam expanding agents), heating media, gaseous dielectric bodies, fire extinguishing agents and fire controlling agents, power cycle working fluids, polymerization media, carrier fluids, buffing compounds, substitute drying agents, and the like.

Note that when the present invention is used as a cleaning agent, a subject to be cleaned by the azeotropic composition or azeotrope-like composition of the present invention is not particularly limited, but the present invention can be suitably used in electronic, electric, and mechanical parts and the like, or small automotive parts and the like, which should be continuously produced and cleaned, and the like.

Of these, the azeotropic composition or azeotrope-like composition of the present invention can be suitably used as a cleaning agent for cleaning a solid surface having grime of an organic component (oil) or inorganic component, for example, semiconductor surfaces, electronic substrate surfaces, CMOS (Complementary Metal Oxide Semiconductor), MEMS (Micro Electro Mechanical Systems), hard disk surfaces, and other surfaces having a fine structure.

In one embodiment of the present disclosure, the method of contacting may be accomplished by spraying, flushing, wiping with a substrate e.g., wiping cloth or paper, that has the cleaning composition incorporated in or on it. In another embodiment of the present disclosure, the method of contacting may be accomplished by dipping or immersing the article in a bath of the cleaning composition.

In one embodiment of the present disclosure, the process of recovering is accomplished by removing the surface that has been contacted from the cleaning composition bath. In another embodiment of the invention, the process of recovering is accomplished by allowing the cleaning composition that has been sprayed, flushed, or wiped on the disk to drain away. Additionally, any residual cleaning composition that may be left behind after the completion of the previous steps may be evaporated in a manner similar to that for the deposition method.

The method for cleaning a surface may be applied to the same types of surfaces as the method for deposition as described below. Semiconductor surfaces or magnetic media disks of silica, glass, metal or metal oxide, or carbon may have contaminants removed by the process of the invention. In the method described above, contaminant may be removed from a disk by contacting the disk with the cleaning composition and recovering the disk from the cleaning composition.

In yet another embodiment, the present method also provides methods of removing contaminants from a product, part, component, substrate, or any other article or portion thereof by contacting the article with a cleaning composition of the present disclosure. As referred to herein, the term “article” refers to all such products, parts, components, substrates, and the like and is further intended to refer to any surface or portion thereof.

As used herein, the term “contaminant” is intended to refer to any unwanted material or substance present on the article, even if such substance is placed on the article intentionally. For example, in the manufacture of semiconductor devices it is common to deposit a photoresist material onto a substrate to form a mask for the etching operation and to subsequently remove the photoresist material from the substrate. The term “contaminant,” as used herein, is intended to cover and encompass such a photo resist material. Hydrocarbon based oils and greases and dioctylphthalate are examples of the contaminants that may be found on the carbon coated disks.

In one embodiment, the method of the invention comprises contacting the article with a cleaning composition of the invention, in a vapor degreasing and solvent cleaning method. In one such embodiment, vapor degreasing and solvent cleaning methods consist of exposing an article, preferably at room temperature, to the vapors of a boiling cleaning composition. Vapors condensing on the object have the advantage of providing a relatively clean, distilled cleaning composition to wash away grease or other contamination. Such processes thus have an additional advantage in that final evaporation of the present cleaning composition from the object leaves behind relatively little residue as compared to the case where the object is simply washed in liquid cleaning composition.

In particular, the azeotropic composition or azeotrope-like composition of the present invention forms an azeotrope-like composition that has high oil removal properties and excellent cleaning properties and that exhibits the same behavior as a single compound, in conjunction with having high safety, being friendly to the global environment, and having excellent polymer compatibility (where polymer attack properties are suppressed). Therefore, the azeotropic composition or azeotrope-like composition is suitable for cleaning resin products.

Furthermore, the azeotropic composition or azeotrope-like composition of the present invention is also suitable for use as a coolant, for refrigeration purposes. In particular, the composition exhibits azeotropy, and therefore, the composition is also suitable as a refrigerant for use in a cooling method (evaporation cooling) that includes a step of condensing the composition of the present invention and a step of evaporating near an object to be cooled. Additionally, the azeotropic composition or azeotrope-like composition of the present invention is particularly suited for use as a foaming agent (foam expansion agent) when manufacturing thermoplastic or thermosetting foam.

The present invention is described below in detail based on examples.

### EXAMPLES

Measurements and calculations of the boiling point, surface tension, density, viscosity, and flash point of a mixture containing HFE and HCFO-1233yd or HCFO-1233zd and an oil removal rate test and resin compatibility test were performed by the following methods.

### [Boiling Point (Equilibrium Reflux Boiling Point)]

The boiling point (equilibrium reflux boiling point) was measured in accordance with JIS K 2233 with the exception that the cooling water temperature was set to 5° C., and that heating was performed directly without anything placed between the hot plate and the flask.

### Density: Amaqat's Law

$$\\ {V}_{m} = \sum {x}_{j} {V}_{j}$$

$$\\ V : Density$$

$$\\ x : Molar fraction$$

Note that the density value of HFE was 1.52 g/mL for methyl nonafluorobutyl ether, 1.43 g/mL for ethyl nonafluorobutyl ether, and 1.47 g/mL for 2,2,2-trifluoroethyl-1,1,2,2-tetrafluoroethyl ether (published manufacturer value, 25° C. setting), the density of HCFO-1233yd was 1.39 g/mL (cited from AGC Research Report 69 (2019), Development of Environmentally Friendly Fluorine-Based Solvent AMOLEA® AS-300), and the density of HCFO-1233zd was 1.31 g/mL (cited from Central Glass Co., Ltd., 1233Z Next Generation Fluorine-Based Solvent with Excellent Environmental Performance and High Cleaning Power, October 2015).

The viscosity of the composition was calculated using the following equation.

### Viscosity: McAllister Method

$$\\ ln {η}_{m} = \sum {x}_{i} f ( {η}_{i} )$$

$$\\ η : Viscosity$$

$$\\ x : Molar fraction$$

$$\\ f ( η ) : Log of viscosity$$

Note that the viscosity of HFE was 0.58 mPa-s for methyl nonafluorobutyl ether, 0.57 mPa-s for ethyl nonafluorobutyl ether, and 0.65 mPa-s for 2,2,2-trifluoroethyl-1,1,2,2-tetrafluoroethyl ether (published manufacturer value, 25° C. setting), the viscosity of HCFO-1233yd was 0.57 mPa-s (cited from AGC Research Report 69 (2019), Development of Environmentally Friendly Fluorine-Based Solvent AMOLEA® AS-300), and the viscosity of HCFO-1233zd was 0.41 mPa-s (cited from Central Glass Co., Ltd., 1233Z Next Generation Fluorine-Based Solvent with Excellent Environmental Performance and High Cleaning Power, October 2015).

### Surface Tension

The surface tension of the composition was calculated using the following equation.

### Surface Tension: Macleod-Sugden Correlation Equation

$$\\ {σ}^{{}_{} 1 / 4} = [ P ] ( {ρ}_{L} - {ρ}_{V} ) / MW$$

$$\\ σ : Surface tension$$

$$\\ P : Parachor constant$$

$$\\ {ρ}_{L} : Liquid specific gravity$$

$$\\ {ρ}_{V} : Vapor specific gravity$$

$$\\ MW : Molecular weight$$

Note that the surface tension of HFE was 13.6 mN/m for methyl nonafluorobutyl ether, 13.6 mN/m for ethyl nonafluorobutyl ether, and 16.4 mN/m for 2,2,2-trifluoroethyl-1,1,2,2-tetrafluoroethyl ether (published manufacturer value, 25° C. setting), the surface tension of HCFO-1233yd was 21.7 mN/m (cited from AGC Research Report 69 (2019), Development of Environmentally Friendly Fluorine-Based Solvent AMOLEA©AS-300), and the surface tension of HCFO-1233zd was 18.6 mN/m (cited from Central Glass Co., Ltd., 1233Z Next Generation Fluorine-Based Solvent with Excellent Environmental Performance and High Cleaning Power, October 2015).

### Flash Point

The flash point was measured by the Tag closed and Cleveland open flash point test in accordance with JIS K 2265-1980.

### Oil Removal Rate

The oil removal rate is used as an index indicating cleaning performance. The oil removal rate was calculated by the following equation.

$$\\ Oil Removal Rate ( \% ) = \frac{( \begin{matrix}Amount of oil adhered to object to be cleaned before cleaning - \\ Amount of oil adhered to object to be cleaned after cleaning\end{matrix} )}{( Mass of oil adhered to object to be cleaned before cleaning )} \times 100$$

### Cleaning Conditions

The compositions shown in Table 1 were used as cleaning agents.

A desktop ultrasonic cleaning machine (3-frequency ultrasonic cleaning machine Model VS-100 III) was used as the device, and cleaning was performed at room temperature with an ultrasonic frequency of 28 kHz, an output of 100 W, and a cleaning time of 3 minutes.

### Resin Compatibility Test (Polycarbonate (PC)

A test piece (2×20×100 mm) containing a PC resin was immersed for 15 minutes at room temperature in the compositions described in Table 1, and then measured for changes in weight and hardness.

The HFE and HCFO-1233yd or HCFO-1233zd used in the Examples and Comparative Examples are as follows.
HFE
Methyl nonafluorobutyl ether
(Novec® 7100, manufactured by 3M®)
Ethyl nonafluorobutyl ether
(Novec® 7200, manufactured by 3M®)
2,2,2-trifluoroethyl-1,1,2,2-tetrafluoroethyl ether
(Asahiklin®AE-3000, manufactured by AGC®)
HFO-1233
HCFO-1233yd
(AMOLEA® AS-300, manufactured by AGC®)
HCFO-1233zd
(Manufactured by Central Glass Co., Ltd.®, CELEFIN® 1233Z)

Furthermore, oils and resins used in the Examples and Comparative Examples are as follows.
Oils
Silicone oil (manufactured by Shin-Etsu Chemical Co., Ltd., KF-96-100)
Resins
PC resin (manufactured by Standard-Testpiece)

### Examples 1 to 6, Comparative Examples 1 to 5

The boiling point, surface tension, density, viscosity, and flash point of the compositions of the invention as well as the HFE, HCFO-1233yd, and HCFO-1233zd are shown in Table 1. Table 1 shows the oil removal rates for Examples 1 to 6 and Comparative Examples 1 to 3 as well as the PC resin compatibility test results.

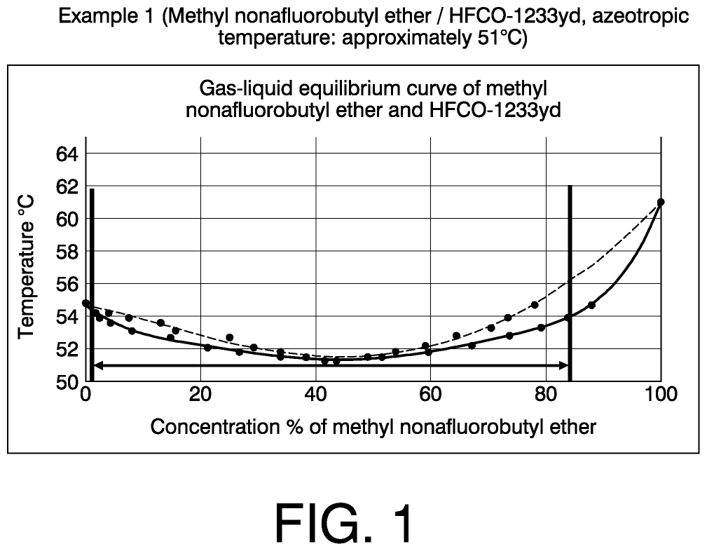

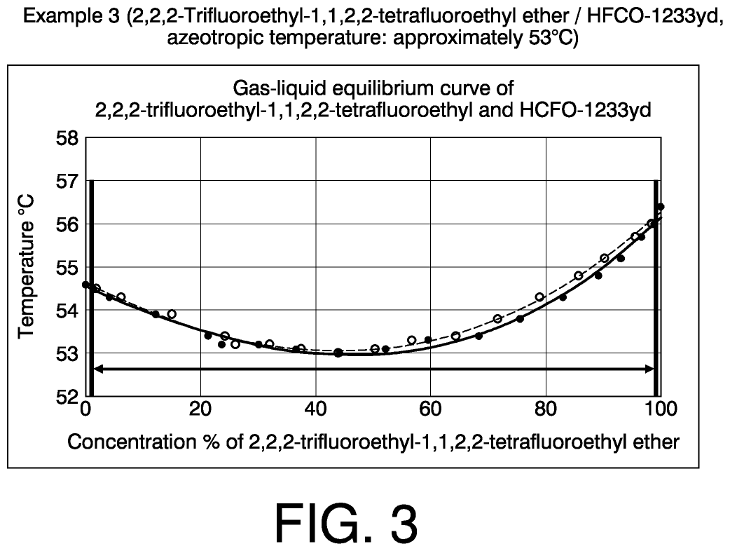

Furthermore, the gas-liquid equilibrium curves for Examples 1 to 6 are shown in FIGS. 1 to 6 respectively. In FIGS. 1 to 6, the solid lines depict the liquid-phase lines and the dotted lines depict the gas-phase lines. Additionally, with the exception of FIG. 3, the boxed temperatures in the figures are maximum values in the range of each composition (among boxed composition % in the figures, the largest value), and are temperatures depicted by the liquid-phase lines and the gas-phase lines. Note that in FIG. 3, the boxed temperatures in the figure are temperatures for compositions having a largest difference in a gas-phase line and a liquid-phase line (2,2,2-trifluoroethyl-1,1,2,2-tetrafluoroethyl ether has a mass % of 83.0).

FIG. 1 shows azeotropy, where the mass ratio of methyl nonafluorobutyl ether/HCFO-1233yd is 45/55, at a minimum boiling point of 51° C., and an azeotrope-like shape in the range of 0.1/99.9 to 83.0/17.0, confirming a temperature difference in the gas-phase line and the liquid-phase line as being within 2° C.

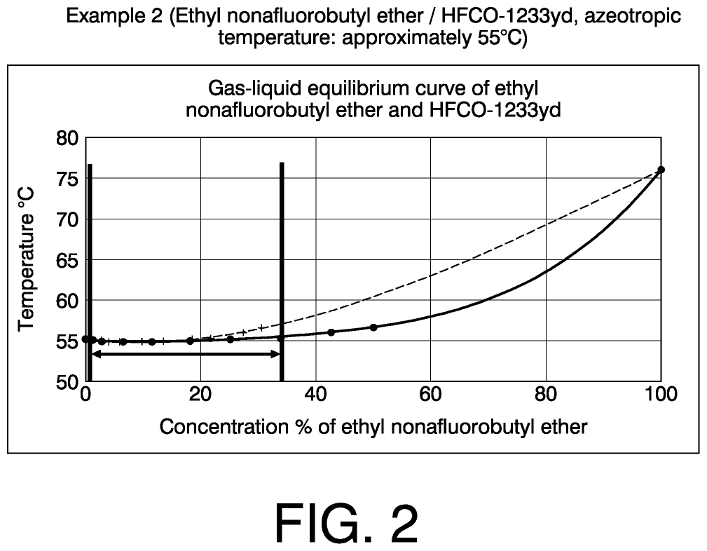

FIG. 2 shows azeotropy, where the mass ratio of ethyl nonafluorobutyl ether/HCFO-1233yd is 2.8/97.2 to 11.5/88.5, at a minimum boiling point of 54.9° C., and an azeotrope-like shape in the range of 0.1/99.9 to 35.0/65.0, confirming a temperature difference in the gas-phase line and the liquid-phase line as being within 2° C.

FIG. 3 shows azeotropy, where the mass ratio of 2,2,2-trifluoroethyl-1,1,2,2-tetrafluoroethyl ether/HCFO-1233yd is 45/55, at a minimum boiling point of 53° C., and an azeotrope-like shape in the range of 0.1/99.9 to 99.9/0.1, confirming a temperature difference in the gas-phase line and the liquid-phase line as being within 2° C.

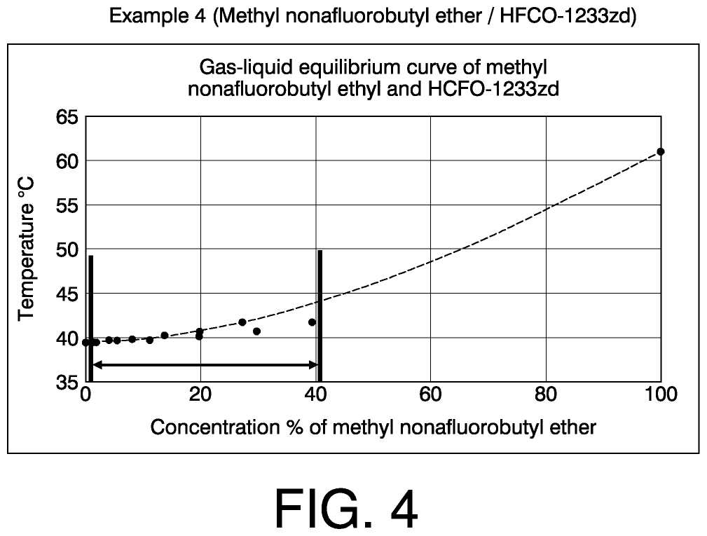

FIG. 4 shows an azeotrope-like shape in the range where the mass ratio of methyl nonafluorobutyl ether/HCFO-1233zd is 0.1/99.9 to 40.5/59.5, confirming a temperature difference in the gas-phase line and the liquid-phase line as being within 2° C.

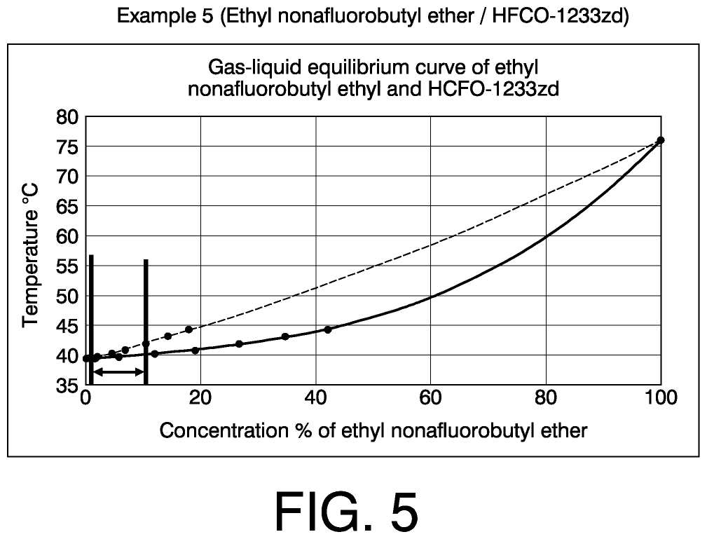

FIG. 5 shows an azeotrope-like shape in the range where the mass ratio of ethyl nonafluorobutyl ether/HCFO-1233zd is 0.1/99.9 to 11.0/89.0, confirming a temperature difference in the gas-phase line and the liquid-phase line as being within 2° C.

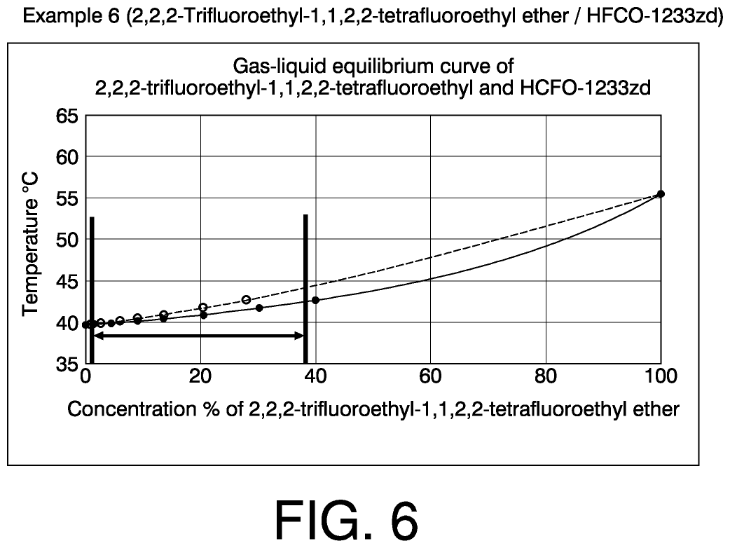

FIG. 6 shows an azeotrope-like shape in the range where the mass ratio of 2,2,2-trifluoroethyl-1,1,2,2-tetrafluoroethyl ether/HCFO-1233zd is 0.1/99.9 to 38.0/62.0, confirming a temperature difference in the gas-phase line and the liquid-phase line as being within 2° C.

Moreover, in FIG. 1, polymer attack properties (a significant change in hardness in the polycarbonate resin) are observed for Comparative Example 4, whereas suppression of polymer attack properties (change in hardness) is observed for examples 1 to 6.

As shown in Table 1, the compositions of the Examples exhibit excellent oil removal rates and high cleaning power, while also have very low polymer attack properties.

TABLE 1

| | | | Example | Example | Example | Example | Example | Example |
|---|---|---|---|---|---|---|---|---|
| | | | 1 | 2 | 3 | 4 | 5 | 6 |
| Composition | HFE | Methyl | 45 | | | 20 | | |
| (mass %) | | nonafluorobutyl | | | | | | |
| | | ether | | | | | | |
| | | Ethyl | | 9 | | | 10 | |
| | | nonafluorobutyl | | | | | | |
| | | ether | | | | | | |
| | | 2,2,2- | | | 45 | | | 19 |
| | | trifluoroethyl- | | | | | | |
| | | 1,1,2,2- | | | | | | |
| | | tetrafluoroethyl | | | | | | |
| | | ether | | | | | | |
| | HCFO- | 1233yd | 55 | 91 | 55 | | | |
| | 1233 | 1233zd | | | | 80 | 90 | 81 |

| | | | | | | | |
|---|---|---|---|---|---|---|---|
| Properties | GWP | 189 | 5 | 400 | 84 | 5.7 | 169 |
| | MW | 166 | 137 | 155 | 144 | 137.5 | 140 |
| | Boiling point (° C.) | 51 | 55 | 53 | 40 | 40 | 41 |
| | Density (g/mL) | 1.45 | 1.39 | 1.43 | 1.33 | 1.32 | 1.33 |
| | Viscosity (Pa/s) | 0.57 | 0.57 | 0.69 | 0.39 | 1.38 | 0.40 |
| | Surface tension | 18.7 | 21.2 | 19.6 | 17.3 | 17.6 | 17.7 |
| | (mN/m) | | | | | | |
| | Flash point | None | None | None | None | None | None |

| | | | | | | |
|---|---|---|---|---|---|---|
| Oil removal rate, silicone oil (KF-96- | >99.9% | >99.9% | >99.0% | >99.9% | >99.9% | >99.9% |
| 100) | | | | | | |
| Resin compatibility test, change in | 4% | 10% | 2% | <1% | <1% | <1% |
| weight | | | | | | |
| Resin compatibility test, change in | 12% | 42% | 2% | 2% | 2% | <1% |
| hardness | | | | | | |

| | | | Compar- | Compar- | Compar- | Compar- | Compar- |
|---|---|---|---|---|---|---|---|
| | | | ative | ative | ative | ative | ative |
| | | | Example | Example | Example | Example | Example |
| | | | 1 | 2 | 3 | 4 | 5 |
| Composition | HFE | Methyl nonafluorobutyl | 100 | | | | |
| (mass %) | | ether | | | | | |
| | | Ethyl nonafluorobutyl | | 100 | | | |
| | | ether | | | | | |
| | | 2,2,2-trifluoroethyl- | | | 100 | | |
| | | 1,1,2,2-tetrafluoroethyl | | | | | |
| | | ether | | | | | |
| | HCFO- | 1233yd | | | | 100 | |
| | 1233 | 1233zd | | | | | 100 |

| | | | | | | |
|---|---|---|---|---|---|---|
| Properties | GWP | 421 | 57 | 889 | <1 | <1 |
| | MW | 250 | 264 | 200 | 130.5 | 130.5 |
| | Boiling point (° C.) | 61 | 76 | 55.5 | 54 | 39 |
| | Density (g/mL) | 1.52 | 1.43 | 1.47 | 1.39 | 1.31 |
| | Viscosity (Pa/s) | 0.58 | 0.57 | 0.65 | 0.57 | 0.41 |
| | Surface tension (mN/m) | 13.6 | 13.6 | 16.4 | 21.7 | 18.6 |
| | Flash point | None | None | None | None | None |

| | | | | | |
|---|---|---|---|---|---|
| Oil removal rate, silicone oil (KF-96-100) | 95.0% | 97.0% | 86.0% | >99.9% | >99.9% |
| Resin compatibility test, change in weight | <1% | <1% | <1% | 12% | 3% |
| Resin compatibility test, change in hardness | −1% | −3% | −3% | 47% | 4% |

1. An azeotropic composition or an azeotrope-like composition containing a hydrofluoroether and a chlorotrifluoropropene, the azeotropic composition or azeotrope-like composition having a composition in which a temperature difference of a temperature indicated by a gas-phase line and a temperature indicated by a liquid-phase line is within 2° C.

2. The azeotropic composition or the azeotropic-like composition according to claim 1, the hydrofluoroether being at least one type selected from methyl nonafluorobutyl ether, ethyl nonafluorobutyl ether, 2,2,2-trifluoroethyl-1,1,2,2-tetrafluoroethyl ether, and isomers thereof.

3. The azeotropic composition or the azeotropic-like composition according to claim 1, the chlorotrifluoropropene being at least one type selected from 1-chloro-2,3,3-trifluoro-1-propene, 1-chloro-3,3,3-trifluoro-1-propene, and isomers thereof.

4. The azeotropic composition or the azeotropic-like composition according to claim 1, consisting of 0.1 to 83.0 mass % of methyl nonafluorobutyl ether and 17.0 to 99.9 mass % of 1-chloro-2,3,3-trifluoro-1-propene.

5. The azeotropic or azeotrope-like composition of claim 4, consisting of 45.0 mass % of methyl nonafluorobutyl ether and 55.0 mass % of 1-chloro-2,3,3-trifluoro-1-propene, exhibiting a boiling point at atmospheric pressure of 51° C.

6. The azeotropic composition or the azeotropic-like composition according to claim 1, consisting of 0.1 to 40.5 mass % of methyl nonafluorobutyl ether and 59.5 to 99.9 mass % of 1-chloro-3,3,3-trifluoro-1-propene.

7. The azeotropic composition or the azeotropic-like composition according to claim 1, consisting of 0.1 to 35.0 mass % of ethyl nonafluorobutyl ether and 65.0 to 99.9 mass % of 1-chloro-2,3,3-trifluoro-1-propene.

8. The azeotropic composition or the azeotropic-like composition according to claim 7, consisting of 2.8 to 11.5 mass % of ethyl nonafluorobutyl ether and 88.5 to 97.2 mass % of 1-chloro-2,3,3-trifluoro-1-propene exhibiting a boiling point at atmospheric pressure of 54.9° C.

9. The azeotropic composition or the azeotropic-like composition according to claim 1, consisting of 0.1 to 11.0 mass % of ethyl nonafluorobutyl ether and 89.0 to 99.9 mass % of 1-chloro-3,3,3-trifluoro-1-propene.

10. The azeotropic composition or the azeotropic-like composition according to claim 1, consisting of 0.1 to 99.9 mass % of 2,2,2-trifluoroethyl-1,1,2,2-tetrafluoroethyl ether and 0.1 to 99.9 mass % of 1-chloro-2,3,3-trifluoro-1-propene.

11. The azeotropic composition or the azeotropic-like composition according to claim 10, consisting of 45 mass % of 2,2,2-trifluoroethyl-1,1,2,2-tetrafluoroethyl ether and 55 mass % of 1-chloro-2,3,3-trifluoro-1-propene exhibiting a boiling point at atmospheric pressure of 53° C.

12. The azeotropic composition or the azeotropic-like composition according to claim 1, consisting of 0.1 to 38.0 mass % of 2,2,2-trifluoroethyl-1,1,2,2-tetrafluoroethyl ether and 62.0 to 99.9 mass % of 1-chloro-3,3,3-trifluoro-1-propene.

13. A method for removing residue from a surface of an article comprising:
a. contacting said surface with a composition comprising an azeotropic or azeotrope-like compositions of claim 1; and
b. recovering said surface from the composition.

14. The method of claim 13, wherein the composition is accomplished by vapor degreasing.

15. The method of claim 14, wherein said contacting is accomplished by wiping the surface with an object saturated with the composition.
